(19) United States
(12) Patent Application Publication
(10) Pub. No.: US 2008/0054576 A1
(43) Pub. Date: Mar. 6, 2008

(54) Method for Controlling the Air Flow in a Level Control System for a Motor Vehicle

(75) Inventors: Heike Ilias, Wedemark (DE); Uwe Folchert, Lauenau (DE); Dierk Hein, Wedemark (DE)

Correspondence Address: Gerlinde M Nattler;Continental Teves Inc, One Continental Drive, Auburn Hills, MI, 48326, US

(73) Assignee: Continental Teves AG & Co., oHG

(21) Appl. No.: 10/571,724

(22) PCT Filed: Jun. 22, 2004
(86) PCT No.: PCT/EP04/06709

§ 371 Date: Apr. 30, 2007

(30) Foreign Application Priority Data
Sep. 18, 2003 (DE) 103 43 094.6

(51) Int. Cl. B60G 17/052

(52) U.S. Cl. 280/5.514; 267/64.28; 280/124.16

(57) ABSTRACT

The invention relates to a method for controlling air flow in a level control system for a motor vehicle. Two air flow intervals are indicated for controlling air flow. The first air flow interval I1 is located entirely within air flow interval I2. If the air flow in the level control system is located outside air flow interval I2, an automatic adjustment is made in air flow interval I2. If the air flow is still located outside air flow interval I1 and within second air flow interval I2, the air flow is adjusted to the first air flow interval I1 exclusively when the motor vehicle is in operation.

The invention relates to a method for controlling the air flow in a level control system for a motor vehicle, which contains the following components:
a compressor
a compressed air accumulator which can be filled with air from the atmosphere and which can be emptied into the atmosphere,
at least one pneumatic spring, the pneumatic spring being connected to the compressed air accumulator via the compressor in such a way that compressed air can be transferred from the pneumatic spring into the compressed air accumulator and in the opposite direction,
the control taking place in such a way that the air flow is within defined limits.

A method of this type controlling the air flow in a level control system for a motor vehicle is known from DE 101 22 567 C1. In the method known from this publication, the control of the air flow takes place within defined limits of an air flow interval which can be selected such that, even in the event of temperature fluctuations, the air flow lies within the air flow interval over a lengthy period of time. In this case, the lower limit of the air flow interval for a low ambient temperature (corresponding to a low air flow) and the upper limit of the air flow interval for a high ambient temperature (corresponding to a high air flow) are predetermined. For example, for the level control system of a motor vehicle, an air flow interval may be predetermined which covers a temperature range of 15° C. +/−20° C. (that is to say, the air flow interval extends from −5° C. to 35° C.). If it is assumed that the motor vehicle is moving at a mean ambient temperature of 15° C., the air flow located in the level control system does not depart from the predetermined air flow interval even in the event of pronounced temperature fluctuations of +/−20° C. An adjustment of the air flow on account of temperature fluctuations of the ambient temperature is therefore not necessary in the method known from DE 101 22 567 C1.

It is therefore to be noted that DE 101 60 972 C1 discloses a method for controlling the air flow in a level control system for a motor vehicle, which demands a low control requirement and thus contributes to the care and long-term durability of All the components (in particular, the compressor) of the level control system. It must be stated, however, that, in the method known from this publication, it may happen, due to the size of the predetermined air flow interval, that the control speeds specified by the vehicle manufacturers cannot be maintained. This is the case particularly when the air flow in the level control system is in proximity to the lower or the upper limit of the air flow interval. When the air flow is in proximity to the lower limit of the air flow interval, the motor vehicle cannot be lifted from a low level sufficiently quickly, since the air flow in the level control system is too low. If, by contrast, the air flow in the level control system is in proximity to the upper limit of the air flow interval, the motor vehicle cannot be lowered from a high level sufficiently quickly, since the level control system contains too much air flow which cannot be transferred sufficiently quickly into the compressed air accumulator or into the atmosphere.

The object on which the invention is based is to provide a method for controlling the air flow in a level control system for a motor vehicle, which, on the one hand, Allows a high control speed of the level control system and, on the other hand, does not lead to frequent control operations in the level control system.

According to the characterizing features of claim 1, the object is achieved in that
two air flow intervals are predetermined, the first air flow interval lying within the second air flow interval, and the first air flow interval having a first upper limit and a first lower limit and the second air flow interval a second upper limit and a second lower limit, and,
in any event, a control of the air flow into the second air flow interval takes place when the air flow lies outside the second air flow interval before control, and,
under specific preconditions, a control of the air flow into the first air flow interval is carried out when the air flow lies outside the first air flow interval and within the second air flow interval before control.

The basic idea of the invention is to be seen in that a first narrow air flow interval is predetermined, which lies completely within a second wide air flow interval. The first air flow interval covers a narrow temperature range and is preferably selected such that the level control system satisfies All control speed requirements in this air flow interval. Control of the air flow into the first air flow interval is carried out only under specific predetermined preconditions which indicate that a high control speed of the level control system is desired. This is the case when the motor vehicle is in operation. As long as the motor vehicle is in operation, a control of the air flow in the level control system takes place in such a way that (after the air flow has been controlled into the first air flow interval) the air flow Always remains in the first interval. Consequently, when the motor vehicle is in operation, a high control speed is ensured. The second air flow interval is preferably selected such that it covers a large temperature range.

The invention achieves the advantage that only a few operations to control the air flow are necessary in the level control system. This is attributable to the fact that the second air flow interval selected is very wide and the air flow in the level control system therefore lies only rarely outside this air flow interval. The invention achieves the advantage, furthermore, that, at the same time, a high control speed of the level control system is ensured when this is desired. In this case, control within the first narrow air flow interval is carried out.

According to a development of the invention as claimed in claim 2, in the event that the air flow lies outside the second air flow interval, control is carried out in such a way that, after control, the air flow
lies between the second lower limit and the first lower limit when the air flow lay below the second lower limit before control, and
lies between the second upper limit and the first upper limit when the air flow lay above the second upper limit before control.

The development achieves the advantage that only a low air flow has to be filled up into the level control system or discharged from it when the air flow in the level control system lies outside the second air flow interval. Only short compressor running times are therefore necessary, this being beneficial to the useful life of the compressor.

A development of the invention as claimed in claim 3 is characterized in that, when the air flow lies outside the first air flow interval and within the second air flow interval, control of the air flow into the first air flow interval is carried out under the precondition that the motor vehicle has previously been put into operation. The advantage of this development is to be seen in that putting the motor vehicle into operation can be detected in a simple way (for example, from the fact that the engine is running), and in that the operation of the motor vehicle indicates in a simple way the need for a high control speed of the level control system. As long as the motor vehicle is in operation, the air flow in the level control system is controlled in such a way that it is Always within the first narrow air flow interval, so that a high control speed is ensured during the entire operation of the motor vehicle. Only when the motor vehicle is stopped does the control of the level control system Allow the air flow to lie outside the first air flow interval. Control of the air flow is carried out again only when the air flow departs from the second air flow interval.

According to a development of the invention as claimed in claim 4, a control of the air flow into the first air flow interval is carried out under the additional precondition that a specific time span has elapsed after the motor vehicle has been put into operation. The advantage of this development is to be seen in that control of the air flow into the first air flow interval is carried out only when the temperature of the air flow in the level control system has adapted to the ambient temperature at which the motor vehicle is operated. Owing to this procedure, unnecessary control operations within the level control system can be avoided. A further advantage of the development is to be seen in that only a simple time measurement needs to be carried out. There is no need for an additional measurement of the air flow during the time span.

According to a development of the invention as claimed in claim 5, after the motor vehicle has been put into operation, measurements of the air flow are carried out and control of the air flow into the first air flow interval is carried out under the additional precondition that the measured air flow has stabilized. The advantage of this development is to be seen in that control of the air flows into the first air flow interval takes place only when measurements ensure that the measured air flow has stabilized.

A development of the invention as claimed in claim 6 is characterized in that, when the air flow lies below the second lower limit and the level of the motor vehicle is below a safe level, first the motor vehicle is lifted to a safe level and then control of the air flow takes place in such a way that the air flow lies above the second lower limit after control. What is thus achieved by this development is that control of the motor vehicle to a safe level has priority over control of the air flow in the level control system. This achieves the advantage that the motor vehicle is transferred as quickly as possible to a safe level. The safe level to which the motor vehicle is lifted may, for example, be a predetermined low level at which the motor vehicle has sufficient ground clearance and therefore damage to the underbody of the motor vehicle is largely ruled out.

According to a development of the invention as claimed in claim 7, to lift the motor vehicle to a safe level, first the compressed air present in the compressed air accumulator is used, and, if this is not sufficient for lifting to the safe level, to lift the motor vehicle further, compressed air is sucked out of the atmosphere into pneumatic springs of the level control system.

What is achieved by the development is that the compressor has to transfer only a low fraction of compressed air from the atmosphere into the level control system. This achieves the advantage that the compressor has to overcome the high pressure difference between the atmospheric pressure and the pressure in the level control system over a short period of time only, and therefore a high compressor load is minimized.

According to claim 8, in the event that compressed air is transferred out of the atmosphere into the level control system, the following procedure is adopted:
the air flow L₁ in the level control system is determined,
compressed air is transferred out of the atmosphere directly into at least one of the pneumatic springs (2a, . . . , 2d),
then, the air flow L₂ in the level control system is determined,
the differential air flow ΔL=L₁−L₂ is determined,
a scavenging air flow is determined by means of the differential air flow ΔL,
the scavenging air flow is transferred out of the atmosphere into the compressed air accumulator (4) via an air drier (5),
an air flow corresponding to a scavenging air flow is discharged from the compressed air accumulator into the atmosphere via the air drier (5).

In this development, the compressed air is transferred out of the atmosphere into the pneumatic springs directly, that is to say without previously being led via an air drier. This affords the advantage that there is no pressure loss in the compressed air from the atmosphere in the air drier. It must be stated, however, that, when compressed air is transferred out of the atmosphere directly into the pneumatic springs, moisture is introduced into the level control system, since the directly introduced compressed air is not dried. The air flow in the level control system consequently becomes, overall, moister. In order to compensate this, a scavenging air flow is transferred into the level control system via the air drier. The scavenging air flow thus passes as dried air into the level control system, so that, by the air flows being intermixed, the entire air flow in the level control system becomes drier again. The scavenging air flow is in this case dimensioned such that, after this has been transferred into the level control system, the desired moisture of the entire air flow in the level control system is established. An air flow corresponding to the scavenging air flow is discharged into the atmosphere again later via the air drier. As a result, the air drier is regenerated and is available for new drying operations.

According to a development of the invention as claimed in claim 9, the scavenging air flow is transferred into the compressed air accumulator once or in a plurality of cycles. The advantage of once-only transfer is that the entire scavenging air flow is in the level control system in a short period of time. The advantage of a cyclic transfer is that, in this case, the compressor needs to run for only short time intervals, so that high compressor heating is reliably prevented.

According to claim 10, in the event that compressed air is transferred out of the atmosphere into the level control system, the following procedure is adopted:
the air flow L₁ in the level control system is determined,
compressed air is transferred out of the atmosphere into the level control system via an air drier,
then, the air flow L₂ in the level control system is determined,
the differential air flow ΔL=L₁—L₂ is determined,
a regeneration air flow, which is necessary in order to regenerate the air drier, is determined by means of the differential air flow ΔL,
at least the regeneration air flow is transferred out of the atmosphere into the level control system via the air drier and is discharged into the atmosphere again via the air drier for the regeneration of the air drier.

The advantage of this development is to be seen in that, after the level control system has been filled up with compressed air from the atmosphere, the air drier is immediately regenerated and is available again for further drying operations. The development makes use of the fact that the regeneration air flow required for regenerating an air drier is substantially lower than the previously supplied air flow a ΔL. The regeneration air flow can be filled up in a single filling-up operation. In this case, the regeneration air flow is discharged into the atmosphere via the air drier preferably immediately in a single discharge operation. It is likewise possible for the regeneration air flow to be filled up and discharged in a clocked manner in a plurality of steps.

According to a development of the invention as claimed in claim 11, (if the air flow L in the level control system lies below the second lower limit U₂) in addition to the scavenging air flow or regeneration air flow, an air flow L_{z} is transferred into the compressed air accumulator via the air drier and is dimensioned such that, after the transfer of this air flow L_{z}, the air flow L in the level control system lies above the second lower limit U₂. Preferably, the air flow L_{z} is dimensioned such that, after the transfer of this air flow L_{z}, the air flow L in the level control system lies above the first lower limit U₁. The advantage of this development is to be seen in that the additional air flow L_{z} is dried before it enters the level control system.

A development of the invention as claimed in claim 12 is characterized in that, when the air flow lies above the second upper limit and the level of the motor vehicle is above a safe level, compressed air is discharged from the pneumatic springs simultaneously into the compressed air accumulator of the level control system and into the atmosphere. This development achieves the advantage that a rapid lowering of the motor vehicle to a predetermined safe level is possible. This is necessary particularly in the case of high-powered all-terrain vehicles, since these can be moved with extremely high ground clearance on terrain and immediately thereafter, if appropriate, at high speed on a normal road. If the all-terrain vehicle still has the high ground clearance on a normal road, the all-terrain vehicle may tip over at high speeds (on bends).

Claim 13 relates to a method for controlling the air flow in the level control system, which is characterized in that compressed air is discharged out of the pneumatic springs (2a, . . . , 2d) until the motor vehicle is at a safe level.

An exemplary embodiment and further advantages of the invention are explained in connection with the following figures in which:

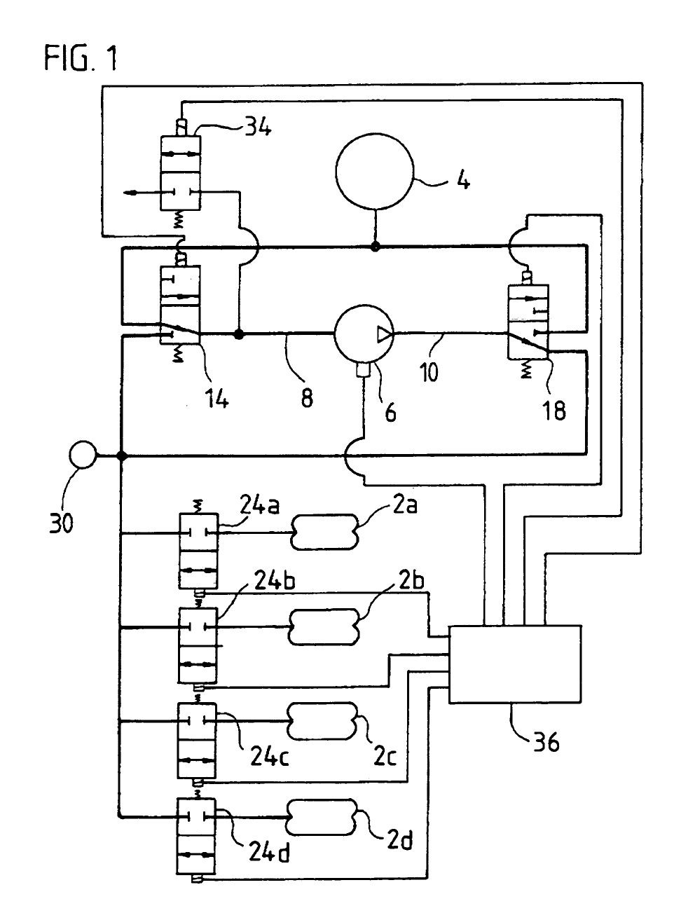

FIG. 1 shows a closed level control system in a diagrammatic illustration,

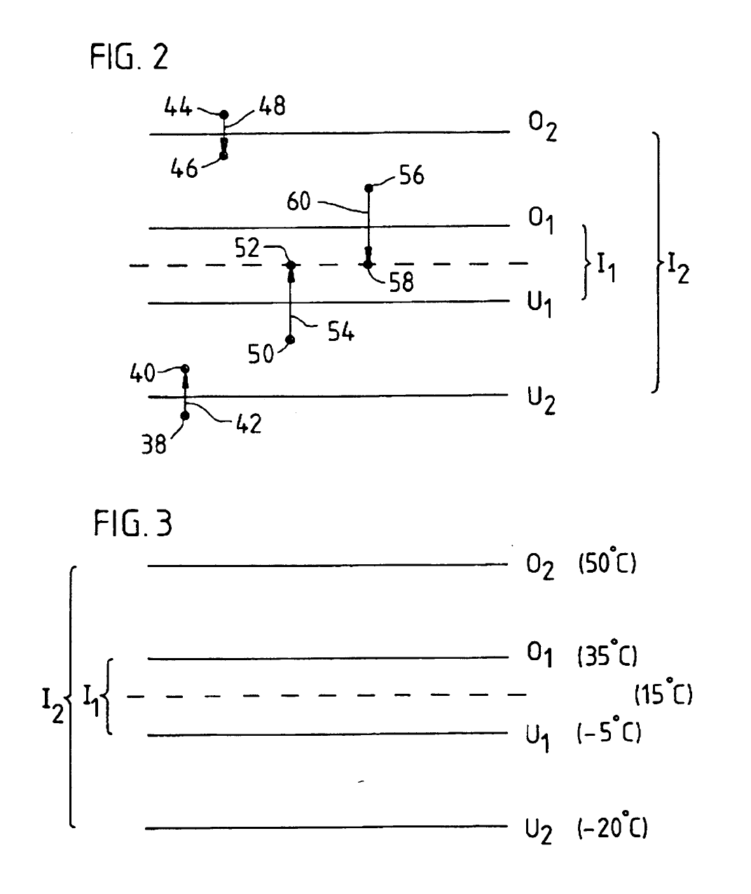

FIG. 2 shows a graph,

FIG. 3 shows a graph,

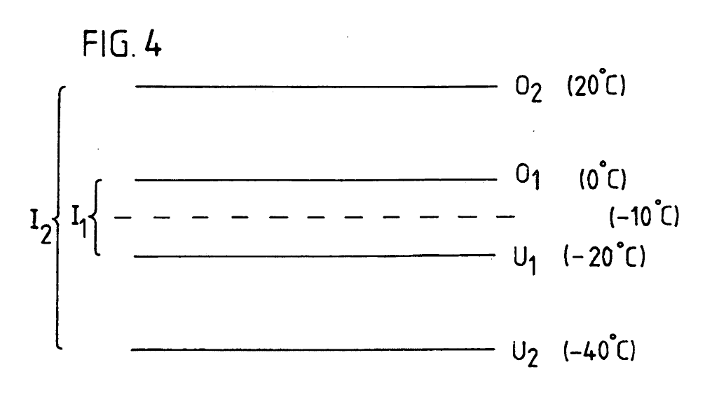

FIG. 4 shows a graph,

FIG. 5 shows a closed level control system in a diagrammatic illustration.

FIG. 1 shows a diagrammatic illustration of a closed level control system which has pneumatic springs 2a to 2d, a compressed air accumulator 4, an air drier 5, a compressor 6 with an inlet 8 and an outlet 10, controllable directional valves 14, 18, 24a to 24d and 34, a pressure sensor 30 and a control unit 36. With the aid of the compressor 6, compressed air can be transferred out of the compressed air accumulator 4 into each of the pneumatic springs 2a to 2d via the directional valves 14, 18 and 24a to 24d when the body of the motor vehicle is to be lifted. Furthermore, with the aid of the compressor 6, compressed air can be transferred into the compressed air accumulator 4 from each of the pneumatic springs 2a to 2d via the directional valves 24a to 24d, 14 and 18 when the body of the motor vehicle is to be lowered and, for this purpose, compressed air to be discharged from the pneumatic springs 2a to 2d. Moreover, with the aid of the compressor 6, compressed air can be transferred out of the atmosphere into the compressed air accumulator 4 via the directional valve 34, the air drier 5 and the directional valve 18 in order to increase the air flow in the level control system. Furthermore, compressed air can be discharged out of the compressed air accumulator 4 into the atmosphere via the directional valve 14, the air drier 5 and the directional valve 34 in order to reduce too high an air flow in the level control system.

Moreover, with the aid of the compressor 6, compressed air can be transferred out of the atmosphere into each individual pneumatic spring 2a to 2d via the directional valve 34, the air drier 5 and the directional valves 18 and 24a to 24d when the body of the motor vehicle is to be lifted with the aid of compressed air from the atmosphere. Furthermore, compressed air can be discharged from each of the pneumatic springs 2a to 2d into the atmosphere via the directional valves 24a to 24d, 14, the air drier 5 and the directional valve 34 when the body of the motor vehicle is to be lowered and, for this purpose, compressed air is to be discharged into the atmosphere. Further, with the aid of the pressure sensor 30, the pressure both in the compressed air accumulator 4 and in the individual pneumatic springs 2a to 2d can be measured. How the individual functions are implemented and in which switching states the controllable directional valves 14, 18, 24a to 24d and 34 are is not to be dealt with in any more detail here, since it is known per se and is described in detail, for example, in DE 199 59 556 C1. All the functions are brought about by the control unit 36 which, for this purpose, activates the controllable directional valves 14, 18, 24a to 24d and 34 so that these change over to the necessary switching states.

In addition to the abovementioned functions, the air flow L in the level control system can be determined, and in this case it has been shown that a sufficiently accurate determination is possible when the air flow in the compressed air accumulator 4 and in the pneumatic springs 2a to 2d is determined, since the air flow in the compressed air lines is negligible. The air flow L is calculated as follows:

L=p₁V₁+p₂V₂+p₃V₃+p₄V₄+pₛVₛ.

With p₁ to p₄: pressure in the pneumatic springs 2a to 2d;

V₁ to V₄: volume of a pneumatic springs 2a to 2d;

pₛ: pressure in the compressed air accumulator 4;

Vₛ: volume of the compressed air accumulator 4.

The determination of the air flow L in a closed level control system is known per se and is described in detail, for example, in DE 101 22 567 C1. It can be gathered from the equation for determining the air flow L that the air flow L is dependent on the temperature (since the individual addends pV are dependent on the temperature according to the ideal gas law). A rise in the temperature signifies a rise in the air flow, and a lowering of the temperature signifies a lowering of the air flow.

When compressed air is discharged from the level control system into the atmosphere via the air drier 5, the air drier is regenerated. The regeneration of the air drier 5 is carried out when compressed air has previously been transferred from the atmosphere into the level control system, since the moisture in the air drier thereby rises. It is explained below how regeneration is carried out in detail: first, before the level control system is filled up with compressed air, the air flow L₁ in the level control system is determined. Then, compressed air is transferred out of the atmosphere into the level control system via the air drier 5. When sufficient compressed air has been transferred into the level control system, the air flow L₂ in the level control system is determined. Then, the differential air flow ΔL=L₁−L₂ is determined, and, by means of the differential air flow ΔL, a regeneration air flow is determined, which is necessary in order to regenerate the air drier 5 (the determination of the regeneration air flow may additionally include information on the air drier 5). In a further step, at least the regeneration air flow is transferred out of the atmosphere into the level control system via the air drier 5 and is thereafter discharged into the atmosphere again via the air drier 5 for the regeneration of the latter. Such a procedure has the advantage, inter alia, that, on the one hand, the air flow is transferred out of the atmosphere to the level control system which is necessary there independently of the regeneration of the air drier 5 (since, for regeneration, an additional air flow from the atmosphere is transferred into the level control system) and, on the other hand, the air drier 5 is regenerated.

It is explained below, in connection with FIGS. 2 to 4, how the air flow L in the level control system is controlled in detail with the aid of the control unit 36 (see FIG. 1).

A first air flow interval I₁ may be gathered from FIG. 2, with a first lower limit U₁ and with a first upper limit O₁ (air flow interval I₁=(U₁; O₁)). Furthermore, a second air flow interval I₂ may be gathered from FIG. 2, with a second lower limit U₂ and with a second upper limit O₂ (air flow interval I₂=(U₂; O₂) ). The first air flow interval I₁ lies completely within the second air flow interval I₂, that is to say O₁<O₂ and U₁>U₂. The two air flow intervals I₁ and I₂ are stored in the control unit 36 (see FIG. 1). When the air flow is located in the first narrow air flow interval, a high control speed (both during lowering and during lifting) of the level control system is possible. I₁ covers fluctuations of the air flow in a small temperature interval and I₂ covers fluctuations in the air flow in a large temperature interval.

The control of the air flow L in the level control system is carried out as follows by means of the control unit 36: it is assumed that the currently determined air flow L in the level control system lies below the lower limit U₂ of the air flow interval I₂, as is indicated by the dot 38. In this case, the control unit 36 brings about a rise in the air flow, specifically until the current air flow L lies within the air flow interval I₂. Preferably, control is carried out in such a way that, after control, the air flow L in the level control system lies between U₁ and U₂, as is indicated by the dot 40 (the control operation is indicated by the arrow 42). In this control, an increase in the air flow takes place in that the compressed air accumulator 4 is filled from the atmosphere by means of the compressor 6 via the directional valves 34 and 18 (see FIG. 1). By the compressed air accumulator 4 being filled, this ensures that the motor vehicle is not lifted undesirably, since no compressed air is transferred into the pneumatic springs 2a-2d.

It is likewise possible that the current air flow L in the level control system lies above the upper limit O₂ of the air flow interval I₂, as is indicated by the dot 44. In this case, the control unit 36 causes the air flow L to be reduced until the current air flow L lies within the second air flow interval I₂. Preferably, in this case, the air flow L is reduced until the current air flow L lies between O₁ and O₂, as is indicated by the dot 46 (the control operation is indicated by the arrow 48). The reduction in the air flow L is brought about by the control unit 36 and leads to compressed air being discharged into the atmosphere from the compressed air accumulator 4 by the directional valves 14 and 34 (see FIG. 1). The discharge of compressed air from the compressed air accumulator 4 ensures that, in the case of a reduction in the air flow L in the level control system, the level of the body of the motor vehicle does not change, since no compressed air is discharged from the pneumatic springs 2a to 2d.

The control operations, indicated by the arrows 42 and 48, in which the current air flow L lay outside the second air flow interval I₂ before control, are carried out in any event and at any time (that is to say, independently of the operating state of the motor vehicle; the control operations are therefore carried out both when the motor vehicle is out of operation (which may be detected, for example, from the fact that the engine is not running) and when the motor vehicle is in operation), when a corresponding air flow L is detected.

By contrast, a control of the air flow L takes place solely under specific preconditions when the air flow lies outside the first air flow interval I₁ and within the second air flow interval I₂ before control. If the preconditions are not fulfilled, control does not take place. This is explained below: it is assumed that, before control, a current air flow L is detected which lies below the lower limit U₁ of the air flow interval I₁ and above the lower limit U₂ of the air flow interval I₂, as is indicated by the dot 50. In this case, under specific preconditions, a control of the air flow L into the first air flow interval I₁ is carried out, as is indicated by the dot 52 (the operation is indicated by the arrow 54). Preferably, in this case, the air flow L is increased until the current air flow L in the level control system lies in the middle (indicated by the dashed line) of the air flow interval I₁. This achieves the advantage that, after the control of the air flow L, the latter has the highest possible fluctuation width, without departing from the air flow interval I₁. Further adjustment is therefore required only rarely. The rise in the air flow L in the level control system takes place exactly as has already been explained above in connection with the control operation from the dot 38 to the dot 40.

It is likewise possible that the current air flow L lies above the upper limit O₁ and below the lower limit O₂ as is indicated by the dot 56. In this case, when specific preconditions are fulfilled, the current air flow L in the level control system is reduced until this lies in the air flow interval I₁, as is indicated by the dot 58 (the associated control operation is indicated by the arrow 60). In this case, too, preferably sufficient compressed air is discharged from the level control system until the current air flow L in the level control system lies in the middle of the air flow interval I₁, in order to achieve the abovementioned advantage. The discharge of the compressed air from the level control system takes place exactly as has already been explained in connection with the control operation from the dot 44 to the dot 46 (see above).

The preconditions which must be fulfilled so that the control unit 36 (see FIG. 1) brings about the controls into the interval I₁ which are indicated by the arrows 54 and 60 may be selected differently and, for example, as follows and fixed in the control unit 36:
the first precondition may be that the motor vehicle in which the level control system is located is put into operation.
A second alternative precondition may be that, after being put into operation, the motor vehicle has already been in operation for a specific length of time.
The third alternative precondition may be that the motor vehicle is in operation and measurements of the air flow L in the level control system have indicated that the current air flow L has stabilized.

The list is illustrative, and further alternative preconditions may be envisaged.

After control into the first air flow interval I₁ has taken place in the presence of the fixed precondition, control of the air flow takes place as long as the motor vehicle is in operation, in such a way that the air flow remains in the first air flow interval I₁ during operation. Only when the control unit 36 detects that the motor vehicle is no longer in operation does the control unit 36 allow the air flow L to depart from the air flow interval I₁.

FIG. 3 shows a graph with two air flow intervals I₁ and I₂ which basically behave in relation to one another in exactly the same way as the air flow intervals explained in connection with FIG. 2. The air flow intervals I₁ and I₂ are stored in the control unit 36 (see FIG. 1). In the graph according to FIG. 3, it is assumed that the motor vehicle in which the level control system is installed is driven mainly at an ambient temperature which amounts on average to approximately 15° C. (for example, in summer in Western Europe). The air flow interval I₁ is fixed, then, in such a way that the air flow L lies in the middle of this air flow interval at 15° C. Furthermore, the lower limit U₁ of the air flow interval I₁ is to be defined by the air flow L which emerges from the air flow L at 15° C. when the temperature decreases by 20° C. to −5° C. The upper limit O₁ of the air flow interval I₁ is to be defined by an air flow L which emerges from the air flow L at 15° C. when the temperature rises by 20° C. to 35° C. The air flow interval I₁ thus covers air flow fluctuations in a temperature range of −5° C. to 35° C. The air flow interval I₂ is selected such that it covers air flow fluctuations in a temperature range from −20° C. at the lower limit U₂ of I₂ to 50° C. at the upper limit O₂.

When the air flow L is located in the air flow interval I₁, the level control system has a high control speed, that is to say the body of the motor vehicle can be both lifted and lowered quickly. If the air flow L is located outside I₁, control into the air flow interval I₁ takes place when the fixed precondition (see above) is fulfilled. As long as the motor vehicle is in operation, control of the air flow L takes place in such a way that (after the air flow has been controlled into I₁) the air flow remains in I₁. A high control speed is consequently ensured while the motor vehicle is in operation.

### EXAMPLE

(It is assumed, in the example, that the first precondition that the motor vehicle is put into operation is fixed in the control unit.)

When the motor vehicle is stopped at a parking place on a hot summer's day, it heats up sharply, and it may happen that the air temperature in the level control system rises above 35° C. and therefore the current air flow in the level control system lies above the upper limit O₁. As long as the current air flow lies between O₁ and O₂ when the motor vehicle is at a standstill, no control of the air flow takes place. If, however, the air flow lies above O₂ (the temperature therefore rises above 50° C.), control is carried out by the control unit 36 (see FIG. 1) of the level control system in such a way that, with the motor vehicle at a standstill, after control, the air flow again lies between O₁ and O₂ (corresponding control operations are carried out when the current air flow L falls below U₁, that is to say the air temperature falls below −5° C.). When the motor vehicle is put into operation, the air flow L is controlled into the air flow interval I₁ and is held there by means of appropriate adjustments as long as the motor vehicle is in operation.

FIG. 4 likewise shows a graph with two air flow intervals I₁ and I₂, in which it is assumed that the motor vehicle in which the level control system is installed is in operation mainly at an average temperature of −10° C. (for example, in winter in Scandinavia). The air flow interval I₁ covers air flow fluctuations in the temperature range of −20° C. to 0° C. and the air flow interval I₂ covers the temperature range of −40° C. to 20° C. Here, too, a high control speed of the level control system is ensured in the air flow interval I₁. Here, too, control of the level control system takes place in a similar way to the control operations, such as have already been explained in connection with FIGS. 2 and 3, the only difference being that different temperature limits are taken into account in the control.

FIG. 5 shows a diagrammatic illustration of a level control system which corresponds as far as possible to the level control system shown in FIG. 1, and therefore only the differences will be dealt with below. One difference is to be seen in that the level control system according to FIG. 5 has a nonreturn valve 62 instead of the controllable directional valve 34 shown in FIG. 1. The nonreturn valve 62 is oriented such that it shuts off toward the atmosphere. With the aid of the compressor 6, compressed air can be transferred out of the atmosphere into the compressed air accumulator 4 via the nonreturn valve 62. For this purpose, first, the controllable directional valves 14 and 18 are activated by the control unit 36, so that these change over from the switching state shown in FIG. 5 into the other switching state in each case. Then, the control unit 36 activates the compressor 6 so that the latter begins to run. Owing to the vacuum which occurs in the compressor 6, the nonreturn valve 62 opens, so that compressed air is transferred into the compressed air accumulator 4 via the nonreturn valve 62, the compressor 6, the directional valve 18 and an air drier 5 located between the directional valve 18 and the compressed air accumulator 4. In this case, the transferred compressed air is dried in the air drier 5, so that it passes, dried, into the compressed air accumulator 4.

Compressed air can likewise be transferred via the nonreturn valve 62 out of the atmosphere directly into one or more of the pneumatic springs 2a to 2d via the compressor 6, in order to lift the level of the motor vehicle. This is necessary particularly when the air flow L in the level control system lies below the second lower limit U₂ and the level of the motor vehicle is below a safe level. In this case, the motor vehicle is first lifted to a safe level, and then control of the air flow L is carried out in such a way that, after control, the air flow L again lies at least above the second lower limit U₂ (preferably, control of the air flow L is carried out in such a way that the air flow L lies above the first lower limit U₁ again after control). In this case, to lift the motor vehicle to the safe level, first, the compressed air located in the compressed air accumulator 4 is used (this takes place, as has already been explained in connection with FIG. 1). If the compressed air located in the compressed air accumulator 4 is not sufficient to lift the motor vehicle to a safe level, compressed air is sucked in from the atmosphere in order to lift the motor vehicle further. This takes place as follows: when the compressed air present in the compressed air accumulator 4 is exhausted and the compressor 6 continues to suck in compressed air, this gives rise, in the compressor 6, to a vacuum, on account of which the nonreturn valve 62 opens. Consequently, with the aid of the compressor 6, compressed air is sucked in from the atmosphere via the nonreturn valve 62. The sucked-in compressed air passes from the compressor 6 via the directional valve 18 into one or more of the pneumatic springs 2a to 2d (into which of the pneumatic springs 2a to 2d the compressed air passes depends on which of the controllable directional valves 24a to 24d have previously been “switched through” by the control unit 36).

The above statements show that the compressed air is transferred into one or more of the pneumatic springs 2a to 2d from the atmosphere directly, that is to say without previously being led via the air drier 5. This means that the compressed air has not been dried, and therefore the moisture in the air flow L of the level control system rises. The following procedure is adopted in order to compensate this rise: immediately before compressed air is transferred into the level control system via the nonreturn valve 62, the air flow L₁ in the level control system is determined. Then, compressed air is transferred out of the atmosphere via the nonreturn valve 62 directly into one or more of the pneumatic springs 2a to 2d, until the motor vehicle has reached the safe level. After the conclusion of the operation of lifting the motor vehicle, the air flow L₂ in the level control system is determined, and then the differential air flow ΔL=L₁−L₂ is determined (the determination of the air flows L₁, L₂ and ΔL takes place, as has already been explained in connection with FIG. 1). By means of the differential air flow ΔL, a scavenging air flow is determined, which is transferred out of the atmosphere into the compressed air accumulator 4 via the air drier 5 (this takes place, as has already been explained in general above). The scavenging air flow is dried in the air drier 5, so that it passes as dry air into the compressed air accumulator 4. In the course of time, in the level control system, the compressed air located in the compressed air accumulator 4 is intermixed with the compressed air located in the pneumatic springs 2a to 2d, so that the moisture in the entire air flow L decreases again. The scavenging air flow previously transferred into the level control system is dimensioned such that, after intermixing, the desired moisture in the air flow L is at least reached or even undershot (for this purpose, the control unit 36 of the level control system can store a characteristic map which predetermines a scavenging air flow for each calculated differential air flow ΔL; if appropriate, a plurality of characteristic maps may be fixed for a plurality of ambient temperatures, so that the determination of the necessary scavenging air flow can take place as a function of the ambient temperature).

For regenerating the air drier 5, compressed air is discharged later into the atmosphere from the compressed air accumulator 4 via the air drier 5 and the controllable directional valve 64. For this purpose, the control unit 36 activates the directional valve 64 so that the latter changes over from the switching state shown in FIG. 5 to the other switching state. An air flow corresponding to the scavenging air flow is discharged from the compressed air accumulator 4 into the atmosphere via the air drier 5 and the directional valve 64. The air drier 5 is thereby regenerated, substantially more moisture being transferred into the atmosphere from the air drier 5 than was previously “introduced” due to the transfer of the scavenging air flow out of the atmosphere into the compressed air accumulator 4 (since, for the regeneration of an air drier, only ever a smaller quantity than was previously dried has to be discharged). This means that the air drier 5 is “overregenerated” in terms of the scavenging air flow, and, in the discharge operation described, atmospheric moisture which previously enters the air drier 5, possibly as a result of other control operations in the level control system, can also be transferred into the atmosphere.

The scavenging air quantity may be transferred from the atmosphere into the compressed air accumulator 4 via the nonreturn valve 62, the compressor 6, the directional valve 18 and the air drier 5 in a single step or in a plurality of cycles.

In addition to this scavenging air flow, an air flow L_{z} is transferred out of the atmosphere into the compressed air accumulator 4 via the nonreturn valve 62, the compressor 6, the directional valve 18 and the air drier 5. The air flow L_{z} is dimensioned such that, after the transfer of this air flow L_{z}, the entire air flow L in the level control system lies at least above the second lower limit U₂ again (preferably, the air flow L_{z} is dimensioned such that, after the transfer of this air flow L_{z}, the entire air flow L in the level control system lies above the first lower limit U₁ again; as a reminder: in the exemplary embodiment described, it was assumed that the total air flow L lies below the second lower limit U₂ and the motor vehicle is below a safe level).

### LIST OF REFERENCE SYMBOLS

### (Part of the Description)

2a, . . . , 2d Pneumatic spring

4 Compressed air accumulator

5 Air drier

6 Compressor

8 Inlet of the compressor

10 Outlet of the compressor

14 Controllable directional valve

18 Controllable directional valve

24a, . . . , 24d Controllable directional valves

30 Pressure sensor

34 Controllable directional valve

36 Control unit

38 Dot

40 Dot

42 Arrow

44 Dot

46 Dot

48 Arrow

50 Dot

52 Dot

54 Arrow

56 Dot

58 Dot

60 Arrow

62 Nonreturn valve

64 Controllable directional valve

1-14. (canceled)

15. A method for controlling the air flow L in a level control system for a motor vehicle, which vehicle contains the following components:
a compressor (6),
a compressed air accumulator (18) which can be filled with air from the atmosphere and which can be emptied into the atmosphere,
at least one pneumatic spring (2a, . . . , 2d), the pneumatic spring (2a, . . . , 2d) being connected to the compressed air accumulator (18) via the compressor (6) in such a way that compressed air can be transferred out of the pneumatic spring (2a, ..., 2d) into the compressed air accumulator (18) and in the opposite direction, control taking place in such a way that the air flow L is located within specific limits,
wherein the method comprises the following steps:
predetermining two air flow intervals I₁, I₂, the first air flow interval I₁ lying within the second air flow interval I₂, and the first air flow interval I₁ having a first upper limit O₁ and a first lower limit U₁ and the second air flow interval I₂ a second upper limit O₂ and a second lower limit U₂, and,
in any event, controlling the air flow L into the second air flow interval I₂ when the air flow L lies outside the second air flow interval I₂ before control, and,
under specific predetermined preconditions, controlling the air flow L into the first air flow interval I₁ when the air flow L lies outside the first air flow interval I₁ and within the second air flow interval I₂ before control.

16. The method as claimed in claim 15, wherein,
in the event that the air flow L lies outside the second air flow interval I₂, control is carried out in such a way that, after control, the air flow L
lies between the second lower limit U₂ and the first lower limit U₁ when the air flow L lay below the second lower limit U₂ before control, and,
lies between the second upper limit O₂ and the first upper limit O₁ when the air flow L lay above the second upper limit O₂ before control.

17. The method as claimed in claim 15, wherein, when the air flow L lies outside the first air flow interval I₁ and within the second air flow interval I₂, control of the air flow L into the first air flow interval I₁ is carried out under the precondition that the motor vehicle has previously been put into operation.

18. The method as claimed in claim 17, wherein control of the air flow L into the first air flow interval I₁ is carried out under an additional precondition that a specific time span has elapsed after the motor vehicle has been put into operation.

19. The method as claimed in claim 17, wherein, after the motor vehicle has been put into operation, measurements of the air flow L are carried out, and the control of the air flow L into the first air flow interval I₁ is carried out under the additional precondition that the measured air flow L has stabilized.

20. The method as claimed in one of claim 15, wherein, when the air flow L lies below the second lower limit U₂ and the level of the motor vehicle is below a safe level, first, the motor vehicle is lifted to a safe level, and then control of the air flow L takes place in such a way that the air flow L lies above the second lower limit U₂ after control.

21. The method as claimed in claim 20, wherein, to lift the motor vehicle to a safe level, first, the compressed air present in the compressed air accumulator (18) is used, and, if this is not sufficient for lifting to the safe level, to lift the motor vehicle further, compressed air is drawn in from the atmosphere.

22. The method as claimed in claim 21, wherein, in the event that compressed air is transferred from the atmosphere into the level control system, the method comprises the following steps:
determining the air flow L₁ in the level control system,
transferring compressed air out of the atmosphere directly into at least one of the pneumatic springs (2a, . . . , 2d),
then determining the air flow L₂ in the level control system,
determining a differential air flow ΔL=L₁−L₂,
determining a scavenging air flow by means of the differential air flow ΔL,
transferring the scavenging air flow from the atmosphere into the compressed air accumulator (18) via an air drier (5),
discharging an air flow corresponding to the scavenging air flow from the compressed air accumulator (18) into the atmosphere via the air drier (5).

23. The method as claimed in claim 22, wherein the scavenging air flow is transferred into the compressed air accumulator (18) in a plurality of cycles.

24. The method as claimed in claim 22, wherein, in addition to the scavenging air flow or regeneration air flow, an air flow L_{z} is transferred into the compressed air accumulator (18) via the air drier (5) and is dimensioned such that, after the transfer of this air flow L_{z}, the air flow L in the level control system lies above the second lower limit U₂.

25. The method as claimed in claim 15, wherein, for transferring compressed air from the atmosphere into the level control system, the method comprises the following steps:
determining the air flow L₁ in the level control system,
transferring compressed air from the atmosphere into the level control system via an air drier (5),
then determining the air flow L₂ in the level control system,
determining a differential air flow ΔL=L₁−L₂,
determining, by means of the differential air flow ΔL, a regeneration air flow which is necessary in order to regenerate the air drier (5),
transferring at least the regeneration air flow from the atmosphere into the level control system via the air drier (5) and discharging it into the atmosphere again via the air drier (5) for the regeneration of the latter.

26. The method as claimed in claim 15, wherein, when the air flow L lies above the second upper limit O₂ and the level of the motor vehicle is above a safe level, compressed air is discharged from the pneumatic springs (2a, . . . , 2d) simultaneously into the compressed air accumulator (18) and into the atmosphere.

27. The method as claimed in claim 26, wherein compressed air is discharged from the pneumatic springs (2a, . . . , 2d) until the motor vehicle is at a safe level.

28. A level control system for a motor vehicle, comprising the following components:
a compressor (6),
a compressed air accumulator (18) which can be filled with air from the atmosphere and can be emptied into the atmosphere,
at least one pneumatic spring (2a, . . . , 2d), the pneumatic spring (2a, . . . , 2d) being connected to the compressed air accumulator (18) via the compressor (6) in such a way that compressed air can be transferred out of the pneumatic spring (2a, . . . , 2d) into the compressed air accumulator (18) and in the opposite direction,
a control unit (36) which carries out a control of the air flow L in the level control system in such a way that the air flow L is located within specific limits,
wherein the system is capable of predetermining two air flow intervals I₁, I₂ in the control unit (36), the first air flow interval I₁ lying within the second air flow interval I₂, and the first air flow interval I₁ having a first upper limit O₁ and a first lower limit U₁ and the second air flow interval I₂ a second upper limit O₂ and a second lower limit U₂.
